(19) United States
(12) Patent Application Publication
(10) Pub. No.: US 2014/0282944 A1
(43) Pub. Date: Sep. 18, 2014

(54) METHODS AND SYSTEMS OF DEPLOYING CLOUD COMPUTING PLATFORMS

(71) Applicant: Stackinsider Technology LLC, Eden Prairie, MN (US)

(72) Inventor: Jinglei Li, Eden Prairie, MN (US)

(73) Assignee: Stackinsider Technology LLC, Eden Prairie, MN (US)

(21) Appl. No.: 13/969,870

(22) Filed: Aug. 19, 2013

(30) Foreign Application Priority Data
Mar. 12, 2013 (CN) 201310076412.9

(51) Int. Cl. H04L 29/08; H04L 29/06

(52) U.S. Cl. CPC H04L 29/08153; H04L 63/029; H04L 63/0407
USPC 726/6; 709/226; 726/11

(57) ABSTRACT

Systems and methods to deploy a cloud platform are provided. In exemplary embodiments, virtual servers are set up in a physical server to form a resource pool that includes resources. User account information and an online request of a user are received from a remote computing device of the user via a network. Based on the user account information and the online request of the user, custom resources are selected from the resource pool, and allocated for the user. Cloud platform deployment related information includes custom resource information, cloud platform deployment environment information, and cloud platform deployment instructions for example. The cloud platform deployment related information is visually presented, using one or more processors, on a GUI of the computing device of the user to facilitate the user to remotely deploy the cloud platform via the network.

### RELATED APPLICATION

The present application claims the priority benefit of Chinese Patent Application Serial No. 201310076412.9 filed on Mar. 12, 2013 and entitled “Methods and Systems for Providing Deployment Platform in Cloud Computing Environments,” which is incorporated herein by reference in its entirety.

### FIELD

The present application relates generally to cloud computing, and in a specific example embodiment, to deployment of cloud computing platforms in a network.

### BACKGROUND

Cloud computing generally refers to the delivery of computing resources as services from providers to remote consumers over a network (e.g., the Internet). Based on the nature of the delivered resources, cloud computing can be classified into three typical service models, namely Infrastructure as a Service (Iaas), Platform as a Service (PaaS), and Software as a Service (SaaS). At current state, it is a complex, error prone, expensive, and time consuming task to deploy a cloud computing platform and put it into a functioning state.

### BRIEF DESCRIPTION OF THE DRAWINGS

Various ones of the appended drawings merely illustrate example embodiments of the present application and cannot be considered as limiting its scope.

FIG. 1 is a block diagram illustrating an exemplary cloud computing system according to an embodiment.

FIG. 2 is a block diagram illustrating an exemplary cloud computing resource manager according to an embodiment.

FIG. 3 is a flowchart illustrating an example method of deploying a cloud computing platform according to an embodiment.

FIG. 4 is a flowchart illustrating exemplary cloud platform deployment related information that is visually presented to a remote GUI of a user according to an embodiment.

FIG. 5 is a simplified block diagram of a machine in an example form of a computing system within which a set of instructions for causing the machine to perform any one or more of the methodologies discussed herein may be executed.

### DETAILED DESCRIPTION

The following detailed description refers to the accompanying drawings which show, by way of illustration, specific aspects and embodiments in which the present subject matter may be practiced. These embodiments are described in sufficient detail to enable those skilled in the art to practice the present subject matter. In general, well-known instruction instances, protocols, structures, and techniques have not been shown in detail.

As used herein, the term “or” may be construed in either an inclusive or exclusive sense. Additionally, although various example embodiments discussed below focus on a specific network-based environment, the embodiments are given merely for clarity in disclosure. Thus, any type of electronic commerce or electronic business systems, including various system architectures, may employ various embodiments of the management system described herein and is considered as being within a scope of example embodiments. Each of a variety of example embodiments is discussed in detail herein. Various technical terms are defined and/or explained below to more clearly illustrate the various embodiments.

“Public cloud” generally refers to a cloud infrastructure that includes applications, data storage, and other resources, which are available to the general public by a service provider. These services are free or offered on a pay-per-use model. Generally, public cloud service providers (e.g., Amazon®, Microsoft®, and Google®) own and operate their public infrastructures, and offer access to them only via a network (e.g., the Internet).

“Private cloud” generally refers to a cloud infrastructure that is operated solely for a single organization. The private cloud may be managed by the organization or by a third-party.

“Hybrid cloud” generally refers to a combination of public and private clouds, which remain unique entities, and have the benefits of both the public and private clouds.

“Community cloud” generally refers to a cloud infrastructure that shares infrastructures between several organizations from a specific community and/or with common concerns (e.g., security, compliance, and jurisdiction). The community cloud may be managed internally by the community or managed by a third-party.

“Cloud computing platform” (“cloud platform”) generally refers to a set of resources that are delivered by providers to remote consumers over a network, and managed by cloud management software.

A cloud computing platform deployment process (or “cloud platform deployment”) is the procedure of setting up a pool of networked devices and/or software applications so that a certain cloud service can be offered to users. Such services may be infrastructure, platform, or software. Conventionally, the cloud platform deployment may involve complex processes, such as purchase of hardware (e.g., network switches, servers, and storage systems etc.), acquirement of software (e.g., either from local media or through network connections etc.), and configuration of them, among other things. Therefore, it is a complex, error prone, expensive, and time consuming task for a user to deploy a cloud platform and put it into a functioning state.

Embodiments of the present application provide systems and methods to deploy cloud platforms in a network (e.g., the Internet). In exemplary embodiments, virtual servers are set up in a physical server (or multiple physical servers) to form a resource pool that includes resources (e.g., virtual and software resources). User account information of a user may be received from a computing device of the user via the network. An online request of the user may also be received from the computing device of the user via the network. Based on the user account information and the online request of the user, custom resources (e.g., custom virtual resources and custom software resources) are selected from the resource pool, and are allocated for the user. Cloud platform deployment related information (e.g., the custom resources, a cloud platform deployment environment, and cloud platform deployment instructions) is visually presented, using one or more processors, on a graphical user interface (GUI) (e.g., a desktop) of the computing device of the user to facilitate the user to remotely deploy the cloud platform via the network.

FIG. 1 is a block diagram illustrating a cloud computing system 10 according to an embodiment. The cloud computing system 10 may include a cloud resource manager 100, a resource pool 200, a software resource pool 300, a computing device 30 of a user, and a computing device 40 of an administrator, all of which may communicate via Application Programming Interfaces (APIs). An API (not shown in the drawings) generally refers to a library that may include specification of routines, data structures, and protocols, and can be used as an interface by software components to communicate with each other. The main function of an API is to provide a common set of features. The user or the administrator can develop applications by calling API functions to reduce programming tasks. An API may also be middleware to provide data sharing among different cloud platforms.

In an embodiment, multiple virtual servers (or virtual machines) 20 are set up in a physical server 11 (or in several servers 11) to form the resource pool 200. The physical server 11 may include Central Processing Units (CPUs), storage devices, RAMs, network devices, and I/O interfaces. In an embodiment, the resource pool 200 may include resources, such as virtual resources and software resources. The virtual resources of the resource pool 200 may include, for example, virtualized computing resources, virtualized storage resources, and virtualized network resources. The software resources of the resource pool 200 may include pre-configured operating system and software packages that are loaded or pre-loaded in the virtual servers 20 or in the physical server 11.

In an embodiment, the virtual servers 20 in the physical server 11 may communicate with a software resource pool 300 (e.g., a software library), select one or more software packages from the software resource pool 300, and pre-load the selected software packages into the virtual servers 20 as local software resources. The selected software packages may alternatively be pre-loaded into the physical server 11 as local software resources. In an embodiment, the selection of the software packages to be pre-loaded from the software resource pool 300 is based on the usage frequencies of the software packages. For example, the virtual servers 20 may select and pre-load a software package from the software resource pool 300, when the usage frequency of the software package reaches a threshold value within a time frame.

FIG. 2 is a block diagram that illustrates an exemplary cloud computing resource manager 100 according to an embodiment. Referring to FIG. 1 and FIG. 2, the cloud resource manager 100 may include, for example, an account management module 101, a service management module 102, a resource allocation module 103, a deployment engine module 104, a security management module 105, a load balancing module 106, a resource statistics module 107, a software package management module 108, and a database 109. In an embodiment, the cloud resource manager 100 may be loaded on a physical server 11.

The account management module 101 may be configured to receive user account information 1011 of a user (e.g., from a computing device 30 of the user via a network) and to store the user account information 1011 in a database 109. In an embodiment, the user account information 1011 may include, for example, registration application information, authentication information, license information, user role definition information, user-related configuration information, and account activation status information. The account management module 101 may also be configured to track the registered user's login status. In addition, the account management module 101 may further be configured to provide a registration service for a new user. The new user may need to initially fill in the username, the password, and other information for registration purpose. All the information can be saved in a database 109, if authorized by an administrator of the database 109.

The service management module 102 may be configured to receive and parse a user online request 1021 (e.g., from a computing device 30 of the user via a network). In an embodiment, the account management module 101 may save the registration information, user role information and authentication information in the service management module 102. The registration application information of a user may include detailed information about the user name and the password of the user. The user role definition information of a user may include detailed information about the level of the user, and the affiliation with other users. The authentication information of a user may include detailed information about the access authority of the user to the resource pool 200 and the account activation status of the user.

The resource allocation module 103 may be configured to allocate custom virtual resources dedicated for the user from the resource pool 200 based on the user account information 1011 and the online request 1021 of the user.

The resource allocation module 103 may also be configured to allocate custom software resources dedicated for the user based on the user account information 1011 and the online request 1021 of the user. In an embodiment, the resource allocation module 103 may allocate custom software resources dedicated for the user from the software pool 300 based on the user account information 1011 and the online request 1021 of the user. In another embodiment, the resource allocation module 103 may allocate custom software resources dedicated for the user directly from the resource pool 200 based on the user account information 1011 and the online request 1021 of the user. In another embodiment, the resource allocation module 103 may be pre-installed on user's allocated virtual servers with particular operating systems per the user's online request. With the operating systems pre-installed, user cloud deployment process may be shortened and thus efficiency is improved.

The resource pool 200 may include software packages that have been pre-loaded by the virtual servers 20 from the software pool 300, and saved in the virtual servers 20 or in the server 11 as local software packages. For example, a software package that is more frequently used (e.g., the software package having a usage frequency reaching a threshold frequency value within a time frame) can be pre-loaded by the virtual servers 20 from the software pool 300. In this way, the computing device 30 of the user, via the resource manager 100, may get direct access to the pre-loaded software packages from the virtual servers 20, and thus the efficiency of the cloud platform deployment can be enhanced.

The deployment engine module 104 may, using one or more processors, visually present some cloud platform deployment related information on a GUI (e.g., a desktop) of a remote computing device 30 of a user to facilitate the user to remotely deploy the cloud platform via the network. In an embodiment, the cloud platform deployment related information presented to the user may include the custom resources, a cloud platform deployment environment, and cloud platform deployment instructions.

In an embodiment, the custom resources dedicated for the user may include custom virtual resources (such as custom virtual computing resources, custom virtual storage resources, and custom virtual network device resources), and custom software resources (such as custom virtual software packages from a software pool 300, and custom software packages pre-loaded from a software pool 300 into the virtual servers 20 or the resource pool 200).

In an embodiment, the cloud platform deployment environment may include a software defined network, a security module, and/or a security policy. The software defined network refers to a network architecture, in which software management program is used to isolate network devices and data layers in order to achieve a flexible control of the network traffic and provide a platform for core network and application innovations.

In an embodiment, the cloud platform deployment instructions may include instructions that are visually presented on a GUI of a computing device of a user, to provide prompts to the user what to do step by step.

Exemplary codes written in the deployment engine module 104 for visually presenting cloud platform related information to the user are shown below:

```
{% if not status %}
  <div class=“container-fluid” style=“width: auto; padding: 0; height:
  100%”>
    error
  </div>
{% else %}
  <div class=“container-fluid” style=“width: auto; padding: 0; height:
  100%”>
    <iframe id=“dashboard” name=“I1” src=“http://{{ domain }}
    /dashboard/” height=“110%” width=“100%” style=“overflow-y:
    hidden; “frameBorder=“0”> </iframe>
  </div>
{% endif %}
```

The Security Management Module 105 may be configured to isolate the custom resources (such as custom virtual resources 201 and software resources 301) for different users. The security management module 105 may include a firewall and/or a software defined network. In an embodiment, the security management module 105 is connected to the account management module 101, the resource pool 200, and the deployment engine module 104, to isolate user account information 1011, user online requests 1021, custom virtual resources, and custom software resources from different users, and thus to prevent data conflicts among them. Exemplary codes written in the security management module 105 for isolation of the custom virtual resources 201 and software resources 301 are shown below:

```
# This defines the default rules for a newly created network instance:
# The result: all connectivity is disabled to other peers
def_netdev_default_rules (self, ipv4_v6_rules, net_param):
  network_param = self._process_network_param (network_param)
  routing_entries = [network[‘entry’] for (network, _i) in net_param]
  # drop connectivity for ipv4 network devices
  for entry in routing_entries:
    ipv4_v6_net_rules.append(‘-src %s -tgt tgt -action BLOCK %
    (src, tgt))
```

The custom virtual resources 201 and the custom software resources 301 may communicate with each other. Exemplary codes written in the security management module 105 for communications between them are shown below:

```
# This defines the default rules for all network devices a user owns:
# The result: all connectivity is enabled among all network instance
def_user_dev_default_rules (self, ipv4_v6_rules, net_param):
  network_param = self._process_network_param (network_param)
  routing_entries = [network [‘entry’] for (network, _idx) in net_param]
  # drop connectivity for ipv4 network devices
    for src in routing_entries:
    for tgt in routing_entries:
      ipv4_v6_net_rules.append (‘-src %s -tgt tgt -action ACCEPT’ %
      (src, tgt))
```

The load balancing module 106 may be configured to adjust the performance of the resource pool 200 and to release at least a portion of the custom resources for the user based on the utilization states of the virtual servers 20 by the user.

The resource statistics module 107 may be configured to monitor, in real time, the performances of a user, and timely report them to a computing device 40 of an administrator. The performance of the user may include, for example, custom virtual resource consumption, custom software resource consumption, data volume, billing records, and login status of the user. The resource statistics module 107 may also be configured to monitor, in real time, the states of the cloud system, and timely report them to a computing device 40 of the administrator. The states of the cloud system may include software version updates, virtual machine (e.g., virtual servers) states, and consumption of the resource pool 200. If needed, the administrator may use the feedbacks collected from the resource statistics module 107 to manually adjust the resources allocated from the resource pool 200 to the user in order to meet the actual demands of the user.

The software package management module 108 may be used to configure, edit, update, and patch the software resources 301 allocated for the user. In an embodiment, the software resources 301 are retrieved from the software pool 300.

The database 109 may be used to store data retrieved from the account management module 101, the service management module 102, the resource allocation module 103, the deployment engine module 104, the security management module 105, the load balancing module 106, the resource statistics module 107, and/or the software package management module 108. The database 109 may be a SQL database (such as MySQL®) or a NoSQL database (such as Membase®, MongoDB®, Hypertable®, Apache Cassandra®, or CouchDB®).

In an embodiment, multiple IP address namespaces are formed inside the physical server 20, and each IP address namespace can be assigned to the virtual servers 20. Different IP addresses are assigned to different virtual servers 20 in the same IP address namespace. When a user is to deploy a cloud platform, an IP address namespace may be assigned to the user such that the user can be discerned from other users by the assigned IP address namespace.

Specifically, when multiple users are simultaneously deploying their cloud platforms via a network, different IP address namespaces will be assigned to the multiple users. In the same IP address namespace, all the virtual servers 20 have different IP addresses. However, in different IP address namespaces, the virtual servers 20 may have the same IP address, or have different IP addresses.

### Modules, Components, and Logic

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. A non-transitory computer-readable medium may include any computer-readable medium except a transitory propagating signal. It will be appreciated that a decision to implement a module mechanically, in the dedicated and permanently configured circuitry, or in temporarily configured circuitry (e.g., configured by software) may be driven by, for example, cost, time, energy-usage, and package size considerations.

Accordingly, the term module should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connects the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

FIG. 3 is a flowchart illustrating an example method 395 of deploying a cloud computing platform according to an embodiment.

In operation 302, virtual servers (e.g., virtual machines (VMs)) 20 are set up in a physical server 11 (or in multiple physical servers 11). The virtual servers 20 may form a resource pool 200. The resource pool 200 may include virtual resources (which are formed by the virtual servers 20), and software resources. In an embodiment, the software resources may be preloaded by the virtual servers 20 from a software pool 300 into the virtual servers 20 or into the resource pool 200 as local software. The software pool 300 (also called “codes pool”) may be a software library.

In operation 304, the account management module 101 may receive user account information 1011 through an API from a computing device 30 of a user. The account management module 101 may store the user account information in a database 109 that can be accessed by a service management module 102.

In operation 306, the service management module 102 may receive and parse a user online request 1021 from a computing device 30 of the user. The user online request 1021 may specify, for example, the characters of the to-be-installed cloud system (e.g. the number of VMs, the size of the virtual storage, the network speed), the deployment tools or tool chain that the user plans to use, the version of the cloud management system software that the user intends to install, the main applications (e.g., databases, MS Exchange email servers, CRMs, ERPs) that the user wants to put on the to-be-installed cloud platform, the service model (e.g., Iaas, PaaS, or SaaS) of the to-be-installed cloud system, the service time span of the to-be-installed cloud system, the roadmap of follow-on upgrade schedule, the number of customers that the to-be-installed cloud system will serve, and the nature of the to-be-installed cloud system (e.g., a public, private, community, or hybrid cloud system).

In operation 308, the resource allocation module 103 may allocate custom virtual resources and custom software resources dedicated for the user from the resource pool 200 based on the user account information 1011 and the online request 1021 of the user.

The virtual resources (such as storage capacity, computing power, and network bandwidth) can be statically or dynamically allocated from the resource pool 200 per the online request of the user. For example, if the user requests that 10 GB of the hard drive capacity be allocated to one node of the nodes in the cloud platform, the allocation module 103 can take different approaches to meet this online request of the user.

In an example, the resource allocation module 103 may allocate exactly 10 GB hard drive capacity to the node at the creation time. Thereafter, 10 GB hard drive capacity is taken from the resource pool 200, and the user can use all the 10 GB storage space available to the node afterwards. This allocation is static.

In another example, the resource allocation module 103 pre-allocates 4 GB (rather than 10 GB) hard drive capacity to the node at the creation time, and informs the user that there is 10 GB storage space available at this node. Typically, it may take time for the user to use up all the underlining 4 GB storage space pre-allocated to this node. When the pre-allocated 4 GB storage space is used up, module 103 may gradually allocate an extra space (e.g., 0.5 GB) to this node each time. When the extra space 0.5 GB is also used up, the above process can continue until a total of extra 6 GB storage space is allocated to the node. At this time, the node reaches his capacity of 10 GB. This allocation is dynamic, and may be referred to as a thin-provisioning process in computing. By taking the advantage of the dynamic allocation, a user may update his online request on the fly. No matter how the resources are allocated to meet the initial 10 GB storage space, the user may change his request at a later stage. For example, after the cloud platform is built up and on service, the user may change the request (or demand) for a storage space (e.g., from 10 GB to 32 GB). The resource allocation module 103 may allow such a dynamic demand request, and may dynamically allocate the requested hard drive capacity to the node.

In an embodiment, the custom software resources dedicated for the user may be allocated from the software pool 300.

In another embodiment, the custom software resources dedicated for the user may be allocated from the resource pool 200. The resource pool 200 may include software packages that have been pre-loaded by the virtual servers 20 from the software pool 300, and have been saved in the virtual servers 20 (or in the server) as local software packages. For example, a software package having a usage frequency reaching a frequency threshold value within a time frame can be preloaded, by the virtual servers 20, into the virtual servers 20 or the physical server 11 from the software pool 300. Thus, the time used to deploy the cloud platform can be reduced such that the efficiency of the cloud platform deployment can be enhanced.

In operation 310, the deployment engine module 104 may, using one or more processors, visually present cloud platform deployment related information on a GUI (e.g., a desktop) of a remote computing device 30 of a user to facilitate the user to remotely deploy the cloud platform via the network. In an embodiment, the cloud platform deployment related information presented to the user may include the custom resources, a cloud platform deployment environment, and cloud platform deployment instructions.

As shown in FIG. 4, exemplary cloud platform deployment instructions are visually presented to a remote GUI of a computing device 30 of a user according to an embodiment. The user may thus enter the commands in the computing device 30 according to the instructions (e.g., “Update System”, “Config Network”, “Setup NTP Service”, etc.) that are visually presented to the user, and may interactively communicate with the backend of the cloud computing system (such as the cloud resource manager 100, the resource pool 200, the software pool 300, and the cloud management system), to visually deploy the cloud platform step by step based on the instructions. The term NTP represents “Network Time Protocol”.

In operation 312, the Security Management Module 105 may isolate the custom resources (such as virtual resources 201 and software resources 301) for different users. The security management module 105 may include a firewall and/or a software defined network. The software defined network may include a network architecture, in which software management program is used to isolate network devices and data layers in order to achieve a flexible control of the network traffic and provide a platform for core network and application innovations.

### Example Machine Architecture and Machine-Readable Medium

FIG. 5 is a simplified block diagram of a machine in an example form of a computing system within which a set of instructions for causing the machine to perform any one or more of the methodologies discussed herein may be executed. With reference to FIG. 5, an exemplary embodiment extends to a machine in the exemplary form of a computer system 500 within which instructions for causing the machine to perform any one or more of the methodologies discussed herein may be executed. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment.

The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 may include a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a Liquid Crystal Display (LCD) or a Cathode Ray Tube (CRT)). In exemplary embodiments, the computer system 500 also includes one or more of an alpha-numeric input device 512 (e.g., a keyboard), a user interface (UI) navigation device or cursor control device 514 (e.g., a mouse), a touchscreen (not shown), a disk drive unit 516, a signal generation device 518 (e.g., a speaker), and a network interface device 520.

### Machine-Readable Medium

The disk drive unit 516 includes a machine-readable medium 522 on which are stored one or more sets of instructions 524 and data structures (e.g., software instructions) embodying or used by any one or more of the methodologies or functions described herein. The instructions 524 may also reside, completely or at least partially, within the main memory 504 or within the processor 502 during execution thereof by the computer system 500, the main memory 504 and the processor 502 also constituting machine-readable media.

While the machine-readable medium 522 is shown in an exemplary embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media. Specific examples of machine-readable media include non-volatile memory, including by way of exemplary semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks. The machine-readable medium may also comprise non-transitory machine-readable medium.

Although an overview of the inventive subject matter has been described with reference to specific exemplary embodiments, various modifications and changes may be made to these embodiments without departing from the broader spirit and scope of embodiments of the present invention.

What is claimed is:

1. A method for deploying a cloud computing platform, the method comprising:
setting up virtual servers in a physical server to form a resource pool, the resource pool including resources;
receiving user account information from a computing device of a user via a network;
receiving an online request from the computing device of the user via the network;
allocating custom resources of the resources for the user from the resource pool based on the user account information and the online request of the user; and
visually presenting, using one or more processors, cloud platform deployment related information on a Graphical User Interface (GUI) of the computing device of the user to facilitate the user to remotely deploy the cloud computing platform via the network.

2. The method of claim 1, further comprising:
isolating the custom resources for different users by using a firewall.

3. The method of claim 1, further comprising:
isolating the custom resources for different users by using a software defined network, wherein the software defined network includes a network architecture that uses a software management program to isolate network devices and data layers for the different users.

4. The method of claim 1, wherein the cloud platform deployment related information includes the custom resources, a cloud platform deployment environment, and cloud platform deployment instructions.

5. The method of claim 1, wherein the resources include virtual resources and software resources.

6. The method of claim 5, wherein the virtual resources are formed by the virtual servers.

7. The method of claim 5, wherein the software resources are selected and preloaded by the virtual servers from a software pool into the virtual servers.

8. The method of claim 7, wherein the virtual servers select software packages from the software pool based on usage frequencies of the software packages within a time frame, and preload the software packages into the virtual servers to form at least a portion of the software resources.

9. A cloud computing resource manager, comprising:
a user account management module configured to receive user account information of a user from a computing device of the user via a network;
a service management module configured to receive and parse an online request of the user from the computing device of the user;
a resource allocation module configured to dynamically or statically allocate custom resources for the user from a resource pool based on the user account information and the online request of the user; and
a deployment engine module, using one or more processors, configured to visually present cloud platform deployment related information on a GUI of the computing device of the user to facilitate the user to remotely deploy a cloud platform via the network.

10. The cloud computing resource manager of claim 9, further comprising:
a security management module configured to isolate the custom resources for the user from custom resources for other users.

11. The cloud computing resource manager of claim 9, further comprising:
a load balancing module configured to adjust performance of the resource pool and release at least a portion of the custom resources for the user based on virtual server utilization status.

12. The cloud computing resource manager of claim 9, further comprising:
a resource computing module configured to monitor in real time performance of a user and report the performance of the user to a computing device of an administrator.

13. The cloud computing resource manager of claim 12, wherein the performance of the user comprises custom virtual resource consumption, custom software resource consumption, data volume, billing records, and login status of the user.

14. The cloud computing resource manager of claim 9, further comprising:
a code management module configured to configure, edit, update, and patch software resources allocated for the user.

15. The cloud computing resource manager of claim 9, wherein the resource pool comprises virtual resources formed by virtual servers and software resources.

16. The cloud computing resource manager of claim 15, wherein the virtual resources comprise virtual computing resources, virtual storage resources, and virtual network resources, and wherein the software resources comprise software packages pre-loaded in the virtual servers from a software pool by the virtual servers.

17. The cloud computing resource manager of claim 9, wherein the online request of the user specifies characters of a cloud system to be installed, deployment tools to be used, a version of a cloud management system software to be installed, applications to be put on the cloud platform, and service model of the cloud system.

18. A non-transitory machine-readable storage medium in communication with at least one processor, the machine-readable storage medium storing instructions which, when executed by the at least one processor, performs a method comprising:
setting up virtual servers in a physical server to form a resource pool including resources;
receiving user account information from a computing device of a user via a network;
receiving an online request from the computing device of the user via the network;
statically or dynamically allocating custom resources for the user from the resource pool based on the user account information and the online request of the user; and
visually presenting, using one or more processors, cloud platform deployment related information on a GUI of the computing device of the user to facilitate the user to remotely deploy the cloud computing platform via the network.

19. The non-transitory machine-readable storage medium of claim 18, further comprising isolating the custom resources for different users by using a firewall or a software defined network, wherein the software defined network includes a network architecture that uses a software management program to isolate network devices and data layers for the different users.

20. The non-transitory machine-readable storage medium of claim 18, wherein the cloud platform deployment related information includes the custom resources, a cloud platform deployment environment, and cloud platform deployment instructions.
